(19) United States
(12) Patent Application Publication
(10) Pub. No.: US 2012/0193514 A1
(43) Pub. Date: Aug. 2, 2012

(54) Laser-Pointer-Controlled Diorama

(76) Inventor: Barry M. Laxton, Unionville (CA)

(21) Appl. No.: 13/357,575

(22) Filed: Jan. 24, 2012

Related U.S. Application Data
(60) Provisional application No. 61/437,633, filed on Jan. 29, 2011.

(51) Int. Cl. G01J 1/42

(52) U.S. Cl. 250/206

(57) ABSTRACT

The Invention outlines a method of incorporating a laser pointing device, an optical sensor target device, and a communication by laser beam between the laser-pointer device and the optical sensor target device with the goal of effecting the activation or control of a device embodied in a model railroad or diorama. The Invention includes details of an apparatus incorporating an optical sensor target that can distinguish between the states of being hit and being not hit by a laser beam that is emitted from a laser pointing device that is aimed at the target for the purpose of activating or controlling a device embodied in a model railroad or diorama, and presents that fact to another device via an appropriate electrical circuit.

This is a non-provisional application of provisional patent U.S. 61/437,633 filed on Jan. 29, 2011 and I claim all rights:

### BACKGROUND OF THE INVENTION

Model Railroads and other dioramas often embody electrical and electronic Devices that are activated or operated on command by a human operator. The commands are effected by the operator by pressing a button or operating a similar Command Mechanism, which eventually leads to operating the Embodied Device as desired. These Command Mechanisms are located within reach of the operator, either permanently-mounted inside or adjacent to the diorama or on a portable device carried by the operator and that communicates the command to the Embodied Device.

The Embodied Devices are solenoids, motors, servos, lights, sound units, smoke generators, or other electrical devices that pertain to the function of the diorama.

The Command Mechanisms have been implemented in a variety of ways, usually involving a control panel that communicates to the diorama via direct wiring, ultrasonic, radio or infra-red technologies. When there is more than one Embodied Device, the control panel requires either more than one Command Mechanism in a one-to-one correspondence with the Embodied Devices or a multiplexed Command Mechanism that can identify each particular Embodied Device using an addressing technique when a command is to be issued.

There are a number of shortcomings with these implementations, including:
Where there is a one-to-one correspondence between the Command Mechanisms and the Embodied Devices, it is often difficult and time-consuming to identify the location of the corresponding Command Mechanism, particularly if the operator is a visitor or newcomer untrained in the particular control panel in use.
Where there is a one-to-one correspondence between the Command Mechanisms and the Embodied Devices, the electrical wiring between the Embodied Devices and a control panel is often complex and difficult to document, and maintenance and repairs are made more difficult as a result.
Where there is a one-to-one correspondence between the Command Mechanisms and the Embodied Devices, the adding of another Embodied Device requires the construction of a new panel or a modification to an existing panel.
Where the Command Mechanisms are implemented using a multiplexing and addressing method, it is often difficult and time-consuming to remember and dial-in the address of the corresponding Embodied Device, particularly if the operator is a visitor or newcomer untrained in the particular control panel in use or the addresses of the Embodied Devices.
Where the operator wishes to mentally pretend that he is within and part of the diorama (as in a first-person simulation of operating a railroad), the operation of a control panel of any complexity requires that he mentally leave the diorama to effect the operation, which detracts from the goals, continuity and enjoyment of the operation.
Often the operation of the Embodied Devices is time-critical and any delays in timely operation detracts from the effectiveness and enjoyment of the operation.
The penalty for operating the wrong Command Mechanism, by for example pushing the wrong button or dialling-in the wrong address, is possible damage to the diorama or items inside the diorama, or interference with other operators.

### BRIEF SUMMARY OF THE INVENTION

Lasers have been used in arcade-type shooting ranges where the goal is to hit a difficult target. The reward for success is often an activation of an Embodied Device in a diorama.

The invention adapts the idea of the arcade-type laser to the idea of operating a diorama. The difference is that, in the arcade the goal is to succeed at hitting difficult targets and the nature of any Embodied Devices that are activated thereby is of secondary or inconsequential importance, whereas in the Invention the goal is to operate the Embodied Devices, and the hitting of the target is made as easy as possible.

### BRIEF DESCRIPTION OF THE SEVERAL VIEWS OF THE DRAWING

FIG. 1—Laser-Pointer-Controlled Diorama—Overview

FIG. 2—Optical Sensor Target Device—Block Diagram

### DETAILED DESCRIPTION OF THE INVENTION

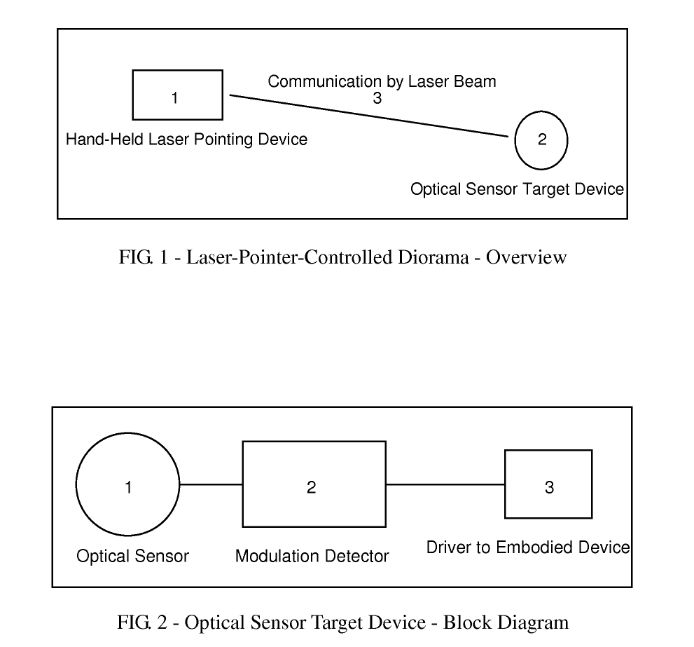

The Invention consists of:
a Hand-Held Laser-Pointing Device (Reference 1 in FIG. 1), which emits a laser beam;
an Optical Sensor Target Device (Reference 2 in FIG. 1), which determines whether or not it is being hit, that is whether or not an appropriate modulated laser beam has been directed toward it, and presents that fact to an Embodied Device in the diorama via an appropriate electrical circuit; and
a Communication By Laser Beam between the laser-pointer device and the optical sensor target device. (Reference 3 in FIG. 1), which contains sufficient information so that the optical sensor target device can distinguish the existence of the laser beam from transient or ambient light or other effect that exists in the area of the diorama.

The information required by the Communication By Laser Beam is incorporated in the Hand-Held Laser-Pointing Device by modulating the laser beam using any method of modulation.

The optical sensor target device incorporates:
an Optical Sensor (Reference 1 in FIG. 2),
a Modulation Detector (Reference 2 in FIG. 2) that is capable of identifying the existence or non-existence of the laser beam, and
an electric Driver (Reference 3 in FIG. 2) that indicates the presence or absence of an appropriate laser beam to an Embodied Device in the diorama.

The laser light is visible, allowing the operator to track the beam toward the target without requiring other aiming facilitators.

The optical sensor target device can be mounted within the diorama so that the operator need not mentally leave the diorama to operate the Embodied Devices.

It is intended that there be a one-to-one relationship between the optical sensor target devices and the Embodied Devices but the invention includes usages that use multiplexing or sequencing of beam hits to effect complex control functions.

It is intended that the optical sensor target devices be mounted near the Embodied Devices so that the operator can easily locate them, identify the appropriate target for the Embodied Device he wishes to activate, and easily hit the target with the beam.

It is intended that the optical sensor target devices be mounted near the Embodied Devices so that the interconnecting wiring be simple, short and direct, thereby eliminating the complexity that often arises from wiring a control panel.

The hand-held laser-pointing device and the optical sensor target device are constructed using standard electronic methodologies.

1. A method of incorporating a laser pointing device, an optical sensor target device, and a communication by laser beam between the laser-pointing device and the optical sensor target device with the goal of effecting the activation or control of a device embodied in a model railroad or diorama.

2. An apparatus incorporating an optical sensor target that can distinguish between the states of being hit and being not hit by a laser beam that is emitted from a laser pointing device that is aimed at the target for the purpose of activating or controlling a device embodied in a model railroad or diorama, and presents that fact to another device via an appropriate electrical circuit.
